(19) United States
(12) Patent Application Publication
(10) Pub. No.: US 2026/0035529 A1
(43) Pub. Date: Feb. 5, 2026

(54) TRANSPARENT HEAT INSULATING MEMBER

(71) Applicant: FUJIFILM Corporation, Tokyo (JP)

(72) Inventors: Ryoji HIMENO, Minamiashigara-shi (JP); Satoshi KUNIYASU, Minamiashigara-shi (JP); Shinichi MORISHIMA, Minamiashigara-shi (JP)

(73) Assignee: FUJIFILM Corporation, Tokyo (JP)

(21) Appl. No.: 19/358,464

(22) Filed: Oct. 15, 2025

Related U.S. Application Data
(63) Continuation of application No. PCT/JP2024/014975, filed on Apr. 15, 2024.

(30) Foreign Application Priority Data
Apr. 20, 2023 (JP) 2023-069101

(51) Int. Cl. C08J 9/36; C08J 3/11; C08J 9/28; C08L 1/02

(52) U.S. Cl. CPC C08J 9/365; C08J 3/11; C08J 9/283; C08L 1/02; C08J 2201/0522; C08J 2201/0546; C08J 2205/026; C08J 2205/042; C08J 2301/02

(57) ABSTRACT

An object of the present invention is to provide a transparent heat insulating member which can maintain transparency in a high-humidity. The transparent heat insulating member according to the embodiment of the present invention is a transparent heat insulating member including a cellulose porous body, in which the cellulose porous body contains a cellulose nanofiber and a water-repellent component, and the cellulose porous body has a fiber diameter of 3 to 40 nm.

### CROSS-REFERENCE TO RELATED APPLICATIONS

This application is a Continuation of PCT International Application No. PCT/JP2024/014975 filed on Apr. 15, 2024, which claims priority under 35 U.S.C. § 119(a) to Japanese Patent Application No. 2023-069101 filed on Apr. 20, 2023. The above applications are hereby expressly incorporated by reference, in their entirety, into the present application.

### BACKGROUND OF THE INVENTION

### 1. Field of the Invention

The present invention relates to a transparent heat insulating member. More specifically, the present invention relates to a transparent heat insulating member consisting of a cellulose porous body.

### 2. Description of the Related Art

Cellulose nanofibers (hereinafter, also referred to as “CNF”) are fibers produced by a pulverization treatment, a chemical treatment, and the like from a pulp or the like, which is a cellulose-based raw material. Since CNF is lightweight and has high strength, CNF is expected to be used in various applications. In addition, CNF is a natural material derived from a plant or a living organism, and is also attracting attention in terms of a small environmental load in a case of disposal or the like.

In addition, the porous body has been used for various applications due to the structure thereof, the specific surface area thereof, and the like. Here, it is expected that the cellulose porous body containing CNF has properties of being lightweight and having high strength.

In general, since CNF is hydrophilic, a surface (internal surface) of a material constituting a cellulose porous body containing CNF is also usually hydrophilic. The porous body has a property of adsorbing other substances on the internal surface thereof, and the cellulose porous body containing CNF having a hydrophilic internal surface is likely to adsorb water. Therefore, the cellulose porous body containing CNF cannot withstand use under high humidity conditions in some cases.

In regard to such problems, JP6212622B discloses a cellulose porous body containing a water-repellent component, in which the water-repellent component is porous, and such a cellulose porous body has water repellency.

### SUMMARY OF THE INVENTION

Since the cellulose porous body containing CNF is an aerogel, the cellulose porous body has excellent heat insulating properties. Therefore, the cellulose porous body containing CNF can be used as a heat insulating member.

Further, such an insulating material may be required to have transparency depending on the applications in some cases. Here, since the insulating material may be used in a high-humidity environment, the heat insulating member may be required to have transparency that is maintained even in a high-humidity environment.

As a result of examination on the cellulose porous body described in JP6212622B, the present inventors have found that the transparency is not sufficient, the transparency is not sufficiently maintained in a high-humidity environment, and thus further improvement is required.

Therefore, an object of the present invention is to provide a transparent heat insulating member in which transparency can be maintained in a high-humidity.

The present inventors have completed the present invention as a result of intensive studies to solve the above-described problems. That is, the present inventors have found that the above-described objects can be achieved by the following configuration.
[1] A transparent heat insulating member comprising: a cellulose porous body, in which the cellulose porous body contains a cellulose nanofiber and a water-repellent component, and the cellulose porous body has a fiber diameter of 3 to 40 nm.
[2] The transparent heat insulating member according to [1], in which the transparent heat insulating member has a maximum length of 1000 mm or greater.
[3] The transparent heat insulating member according to [1] or [2], in which the transparent heat insulating member has a contact angle of 90 degrees or greater with respect to water.
[4] The transparent heat insulating member according to any one of [1] to [3], in which the water-repellent component is a compound containing a fluorinated alkyl group.
[5] The transparent heat insulating member according to [4], in which in the compound containing a fluorinated alkyl group, the fluorinated alkyl group has 4 to 12 carbon atoms.
[6] The transparent heat insulating member according to [4] or [5], in which the compound containing a fluorinated alkyl group is an alkoxysilane containing a fluorinated alkyl group or a condensate of the alkoxysilane.
[7] The transparent heat insulating member according to [6], in which the alkoxysilane is a compound represented by Formula (I).

According to the present invention, it is possible to provide a transparent heat insulating member that can maintain transparency in a high-humidity.

### DESCRIPTION OF THE PREFERRED EMBODIMENTS

Hereinafter, the present invention will be described in detail.

The description of the configuration requirements described below is made on the basis of representative embodiments of the present invention, but it should not be construed that the present invention is limited to those embodiments.

Hereinafter, meaning of each description in the present specification will be explained.

Any numerical range expressed using “to” in the present specification refers to a range including the numerical values before and after “to” as a lower limit value and an upper limit value.

### <Transparent Heat Insulating Member>

A transparent heat insulating member according to the embodiment of the present invention is a transparent heat insulating member consisting of a cellulose porous body, in which the cellulose porous body contains a cellulose nanofiber (CNF) and a water-repellent component, and the cellulose porous body has a fiber diameter of 3 to 40 nm.

The mechanism by which the transparent heat insulating member according to the embodiment of the present invention can maintain the transparency in a high-humidity is not necessarily clear, but the present inventors have presumed as follows.

It is considered that since the transparent heat insulating member according to the embodiment of the present invention consists of a cellulose porous body, and the cellulose porous body has a fiber diameter of 3 to 40 nm, light scattering is likely to be small, and the transparency is excellent.

Here, water adsorbed on the internal surface of the cellulose porous body can aggregate the fibers constituting the cellulose porous body due to the surface tension thereof, and thus the fiber diameter of the cellulose porous body can be increased in a case where water is adsorbed on the internal surface of the cellulose porous body. Meanwhile, it is considered that since the cellulose porous body which is the transparent heat insulating member according to the embodiment of the present invention contains CNF and a water-repellent component, water is unlikely to be adsorbed on the internal surface of the cellulose porous body due to the action of the water-repellent component, and accordingly, the cellulose porous body is unlikely to contain water even in a high-humidity. Therefore, in the transparent heat insulating member according to the embodiment of the present invention, it is considered that the above-described fiber diameter is maintained, and as a result, transparency can be maintained in a high-humidity.

From the viewpoint of expanding the applications of the transparent heat insulating member, it is preferable that the transparent heat insulating member has a maximum length of 1000 mm or greater. The maximum length refers to the maximum length of the continuously formed cellulose porous body. For example, in a case where the transparent heat insulating member has a plate shape and the shape as viewed in a direction perpendicular to one surface of the plate is a rectangle, the maximum length of the transparent heat insulating member corresponds to a length of a long side of the rectangle. In addition, in a case where the transparent heat insulating member has a plate shape and the shape as viewed in a direction perpendicular to one surface of the plate is a circle, the maximum length of the transparent heat insulating member corresponds to a diameter of the circle.

A method of obtaining a transparent heat insulating member (cellulose porous body) having a maximum length of 1000 mm or greater will be described in detail below.

In the transparent heat insulating member, it is also preferable that the contact angle of the transparent heat insulating member with respect to water is 90 degrees or greater from the viewpoint of further maintaining the transparency in a high-humidity. The expression “the contact angle of the transparent heat insulating member with respect to water is 90 degrees or greater” denotes that the contact angle of water on the surface of the transparent heat insulating member is 90 degrees or greater.

The contact angle of the transparent heat insulating member is measured in conformity with the method described in Examples.

The transmittance of the transparent heat insulating member is preferably 30% or greater, more preferably 50% or greater, still more preferably 70% or greater, and particularly preferably 90% or greater. The transmittance of the transparent heat insulating member is usually less than 100%.

The transmittance of the transparent heat insulating member can be increased by reducing the fiber diameter of the cellulose porous body described below. The transmittance of the transparent heat insulating member is measured in conformity with the method described in examples.

Hereinafter, the cellulose porous body constituting the transparent heat insulating member will be described in detail.

### <Cellulose Porous Body>

The transparent heat insulating member according to the embodiment of the present invention consists of a cellulose porous body.

As described above, the cellulose porous body contains CNF and a water-repellent component, and the cellulose porous body has a fiber diameter of 3 to 40 nm.

In the present specification, a small angle X-ray scattering (SAXS) method is employed as a method of measuring the fiber diameter of the cellulose porous body. Specifically, first, X-rays are incident on the cellulose porous body to obtain a pretreatment scattering curve. The scattering intensity in the pretreatment scattering curve is standardized based on the incident X-ray intensity transmitted through a beam stopper, and a standardized scattering curve for the cellulose porous body is obtained. In addition, a blank measurement is performed to obtain a standardized scattering curve for a medium (air) in the same manner as described above. A scattering curve I (q) for the fiber constituting the cellulose porous body is obtained by subtracting the standardized scattering curve for the medium from the standardized scattering curve for the cellulose porous body.

Here, q represents a scattering vector calculated by the following equation using a scattering angle 2θ.

$$q = 4 * π * ( sin ( θ ) ) / λ$$

(π: circumference ratio, 2θ: scattering angle [rad], λ: wavelength of X-rays [nm])

In a case where the scattering curve I(q) of the obtained cellulose porous body is plotted on a double-logarithmic graph, a region where the slope is a straight line appears. A Guinier plot related to the cross section is created for this region, and a scattering intensity average fiber diameter Dc is calculated by the following expression.

$$q * I ( q ) ∝ exp ( - ( {Dc}^{2} * {q}^{2} ) / 16 )$$

The scattering intensity average fiber diameter Dc obtained by the expression shown above is defined as the fiber diameter of the cellulose porous body.

As described above, in the present invention, the fiber diameter of the cellulose porous body is 3 to 40 nm, preferably 5 to 40 nm, and more preferably 10 to 40 nm. In addition, from the viewpoint that the transparency of the transparent heat insulating member is more excellent, the fiber diameter of the cellulose porous body is preferably 3 to 30 nm and more preferably 5 to 20 nm. Meanwhile, from the viewpoint that the transparent heat insulating member can further maintain the transparency in a high-humidity, the fiber diameter of the cellulose porous body is preferably 10 to 40 nm and more preferably 20 to 40 nm.

The fiber diameter of the cellulose porous body can be adjusted by, for example, the fiber diameter and the kind of CNF to be used, the method of forming the cellulose porous body, and the like.

Hereinafter, CNF and the water-repellent component contained in the cellulose porous body, and the components which may be contained in the cellulose porous body will be described.

### [Cellulose Nanofiber]

The cellulose nanofibers (CNF) contained in the transparent heat insulating member according to the embodiment of the present invention are not particularly limited, and known CNF can be used.

Further, CNF denotes fibers obtained by forming a bundle formed of two or more cellulose molecular chains. The expression “forming a bundle formed of two or more cellulose molecular chain” denotes a state where two or more cellulose molecular chains are aggregated to form an aggregate called a microfibril.

CNF is usually obtained by treating fibers derived from a plant. The raw material of CNF is not particularly limited, and examples thereof include fibers derived from plants contained in wood, bamboo, hemp, jute, kenaf, cotton, beet pulp, potato pulp, agricultural product waste, cloth, and paper. The raw materials of CNF may be used alone or in combination of two or more kinds thereof.

CNF may be chemically modified, and from the viewpoint that the transmittance of the transparent heat insulating member is likely to be further increased, a chemically modified CNF is preferable.

In the chemically modified CNF, some or all the groups in the cellulose molecular chain are changed by a chemical treatment. Examples of the cellulose molecular chain in the chemically modified CNF include cellulose molecular chains substituted with other functional groups such as a cellulose molecular chain in which some or all hydroxyl groups at the C6 position in a molecule are oxidized to an aldehyde group, a carboxyl group, or the like, a cellulose molecular chain in which some or all hydroxyl groups including a hydroxyl group at a position other than the C6 position are oxidized, a cellulose molecular chain which is esterified with nitric acid ester, acetic acid ester, phosphoric acid ester, or the like, and a cellulose molecular chain which is etherified with methyl ether, hydroxypropyl ether, carboxymethyl ether, or the like.

Here, more specific examples of the group to be introduced by chemical modification include a carboxy group, an acetyl group, a sulfate group, a sulfonic acid group, an acryloyl group, a methacryloyl group, a propionyl group, a propioloyl group, a butyryl group, a 2-butyryl group, a pentanoyl group, a hexanoyl group, a heptanoyl group, an octanoyl group, a nonanoyl group, a decanoyl group, a undecanoyl group, a dodecanoyl group, a myristoyl group, a palmitoyl group, a stearoyl group, a pivaloyl group, a benzoyl group, a naphthoyl group, a nicotinoyl group, an isonicotinoyl group, a furoyl group, an acyl group such as a cinnamoyl group, an isocyanate group such as a 2-methacryloyloxyethylisocyanoyl group, a methyl group, an ethyl group, a propyl group, a 2-propyl group, a butyl group, a 2-butyl group, a tert-butyl group, a pentyl group, a hexyl group, a heptyl group, an octyl group, a nonyl group, a decyl group, a undecyl group, a dodecyl group, a myristyl group, a palmityl group, an alkyl group such as a stearyl group, an oxirane group, an oxetane group, a thiirane group, and a thietane group.

Among these, it is preferable that the group to be introduced by chemical modification include at least a carboxy group.

The chemical modification of CNF can be performed by a typical method. That is, CNF can be chemically modified by reacting cellulose with a chemical modifier. As necessary, a solvent or a catalyst may be used, or heating, depressurization, or the like may be performed.

Examples of the kind of the chemical modifier include an acid, an acid anhydride, an alcohol, a halogenating reagent, an alcohol, an isocyanate, alkoxysilane, and a cyclic ether such as oxirane (epoxy). These may be used alone or in combination of two or more kinds thereof.

Examples of the acid include acetic acid, acrylic acid, methacrylic acid, propanoic acid, butanoic acid, 2-butanoic acid, and pentanoic acid.

In addition, after the chemical modification, it is preferable to sufficiently perform washing with water in order to terminate the reaction. It is preferable that the resultant is sufficiently washed with water and then substituted with an organic solvent such as an alcohol. In this case, the cellulose is substituted by being immersed in an organic solvent such as an alcohol.

The average fiber diameter of CNF is not particularly limited, but is preferably 1 to 100 nm, more preferably 2 to 50 nm, and still more preferably 2 to 10 nm. A cellulose porous body having a large specific surface area is likely to be obtained by using CNF having an average fiber diameter of 1 to 100 nm. In a case where the average fiber diameter thereof is 1 nm or greater, the single fiber strength of the nanofibers is increased, and the structure of the cellulose porous body is likely to be maintained.

Here, the average fiber diameter is calculated as follows. A transmission electron microscope (TEM) or a scanning electron microscope (SEM) is used to obtain an electron microscope image of the CNF. Random axes of two vertical and two horizontal lines are drawn on each of the obtained images, and the fiber diameter of the fiber intersecting the axes is visually read. In this case, the magnification is any of 5000 times, 10000 times, or 50000 times depending on the size of the fibers constituting the cellulose porous body. Further, the condition for the sample or the magnification is set as the condition that 20 or more fibers intersect with the axis. In this manner, images of at least three non-overlapping surface portions are captured with an electron microscope, and the values of the fiber diameters of the fibers intersecting each of the two axes are read. Therefore, information of a minimum of 20×2×3=120 strands of fibers can be obtained. The number average fiber diameter is calculated from the data of the fiber diameters obtained as described above, and is defined as the average fiber diameter of CNF. In addition, in a case where the length of the branched portion of the branched fiber is 50 nm or greater, the branched fiber is included in the calculation of the fiber diameter as one fiber.

In addition, the average fiber length of CNF is not particularly limited, but is preferably 0.01 to 20 μm and more preferably 0.05 to 10 μm.

Further, the average fiber length is calculated by casting a CNF dispersion liquid thinly on a substrate, freeze-drying the CNF dispersion liquid to obtain a sample, and observing the sample using an SEM. For the obtained observation image, 10 independent fibers are randomly selected per one image, and the fiber length is visually read. In this case, the magnification is any of 5000 times or 10000 times depending on the length of the fibers constituting the cellulose porous body. Further, the fibers whose start points and end points are included in the same image are used as the targets of the sample or the magnification. In this manner, images of at least 12 non-overlapping surface portions are observed with an SEM, and the fiber lengths are read. Therefore, information of at least 10×12=120 strands of fibers can be obtained. The number average fiber diameter is calculated from the data of the fiber diameters obtained as described above, and is defined as the average fiber diameter of CNF. In addition, in a case of the branched fiber, the length of the longest portion of the fiber is defined as the fiber length.

A method of adjusting the average fiber diameter of CNF is not particularly limited, and the average fiber diameter can be adjusted, for example, by a mechanical crushing method of adjusting the average fiber diameter by the treatment time of an ultra-high pressure homogenizer or a grinder to be used and the number of times of the treatment. In addition, in the chemical crushing method, the average fiber diameter can be adjusted by the kind of an oxidizing agent (for example, sodium hypochlorite), the concentration of a catalyst (for example, a TEMPO (2,2,6,6-tetramethyl-1-piperidinyloxy) catalyst), the reaction time, and the like.

A method of preparing CNF is not particularly limited, and a method of mechanically or chemically crushing the cellulose is preferable.

Examples of the method of the mechanical crushing include a method of defibrating an aqueous suspension or a slurry of a cellulose fiber-containing material by mechanically grinding or beating the suspension or the slurry with a refiner, a high-pressure homogenizer, a grinder, a uniaxial or multiaxial kneader, a beads mill, or the like. Examples of the mechanical treatment method include JP5500842B, JP5283050B, JP5207246B, JP5170193B, JP5170153B, JP5099618B, JP4845129B, JP4766484B, JP4724814B, JP4721186B, JP4428521B, WO11/068023A, JP5477265B, and JP2014-84434A.

On the other hand, as the chemical crushing method, for example, a cellulosic raw material is oxidized using an oxidizing agent in the presence of a N-oxyl compound and a bromide and/or an iodide, the oxidized cellulose is subjected to a wet micronization treatment to defibrate into nanofibers, and thus CNF can be produced. Examples of the chemical treatment method include methods described in JP5381338B, JP4981735B, JP5404131B, JP5329279B, JP5285197B, JP5179616B, JP5178931B, JP5330882B, JP5397910B, and the like.

In the cellulose porous body, the content of the CNF is preferably 80% by mass or greater, more preferably 90% by mass or greater, and still more preferably 95% by mass or greater with respect to the total mass of the cellulose porous body.

### [Water-Repellent Component]

The water-repellent component contained in the transparent heat insulating member according to the embodiment of the present invention is not particularly limited as long as a water-repellent function can be imparted, and a known water-repellent component can be used.

Examples of the water-repellent component include a fluorine-based water-repellent agent, a silicone-based water-repellent agent, a wax-based water-repellent agent, an alkyl ketene dimer, and a hydrolysis condensate of alkoxysilane. In addition, preferred examples of the water-repellent component also include a surfactant. Here, the surfactant denotes a compound containing a hydrophobic group and a hydrophilic group in a molecule.

Further, in the transparent heat insulating member according to the embodiment of the present invention, a part of the water-repellent component may react to form a component derived from the water-repellent component. Examples of the component derived from the water-repellent component include a hydrolysis condensate of alkoxysilane.

Among these, a compound containing a fluorinated alkyl group is preferable as the water-repellent component. The fluorinated alkyl group may be a partially fluorinated alkyl group or a perfluoroalkyl group.

The number of carbon atoms in the fluorinated alkyl group is preferably 1 to 20, more preferably 2 to 16, and still more preferably 4 to 12. Further, the number of carbon atoms in the fluorinated alkyl group denotes the number of carbon atoms to which fluorine atoms are bonded, and the number of carbon atoms in the fluorinated alkyl group does not include the carbon atoms to which fluorine atoms are not bonded.

More specifically, preferred examples of the water-repellent component include alkoxysilane containing a fluorinated alkyl group, a hydrolysis condensate of alkoxysilanes containing a fluorinated alkyl group, and a surfactant containing a fluorinated alkyl group. The surfactant containing a fluorinated alkyl group is preferably an anionic surfactant or a cationic surfactant. From the viewpoint of further maintaining the transparency in a high-humidity, it is also preferable that the water-repellent component includes a surfactant containing a fluorinated alkyl group.

As the alkoxysilane containing a fluorinated alkyl group, a compound represented by Formula (I) is preferable.

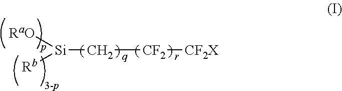

In Formula (I), R^{a} represents an alkyl group having 1 to 4 carbon atoms. In a case where a plurality of R^{a}'s are present, R^{a}'s may be the same as or different from each other. It is preferable that R^{a} represents a methyl group or an ethyl group.

R^{a} represents an alkyl group having 1 to 4 carbon atoms. In a case where a plurality of R^{a}'s are present, R^{a}'s may be the same as or different from each other. It is preferable that R^{b} represents a methyl group or an ethyl group.

p represents an integer of 1 to 3. p represents preferably 2 or 3 and more preferably 3.

q represents an integer of 0 to 10. q represents preferably 0 to 4 and more preferably 0 to 2.

r represents an integer of 0 to 19. r represents preferably 1 to 15 and more preferably 3 to 11.

X represents a hydrogen atom or a fluorine atom. It is preferable that X represents a fluorine atom.

In the cellulose porous body, the content of the water-repellent component is preferably 0.001% to 10% by mass and more preferably 0.01% to 5% by mass with respect to the total mass of the cellulose porous body.

The water-repellent component may be used alone or in combination of two or more kinds thereof. In a case where two or more kinds of water-repellent components are used at the same time, it is preferable that the total content thereof is in the above-described preferable ranges.

### [Additive]

The cellulose porous body may contain an additive other than CNF and the water-repellent component. Examples of the additive include a freeze stabilizer and a strength modifier.

Examples of the freeze stabilizer include sucrose, trehalose, L-arginine, and L-histidine.

Examples of the strength modifier include various latex emulsions such as acrylic latex, NBR-based latex, vinyl acetate-based latex, and olefin-based latex, and water-soluble polymers such as polyacrylamide, polyamide epichlorohydrin, polyvinyl alcohol, and starch.

The content of the additive is preferably 5% by mass or less and more preferably 1% by mass or less with respect to the total mass of the cellulose porous body. The cellulose porous body may contain no additives.

### [Method of Producing Cellulose Porous Body]

A method of producing the cellulose porous body is not particularly limited as long as the cellulose porous body that can be used as a transparent heat insulating member can be produced, but from the viewpoint that a transparent heat insulating member having an excellent transmittance is likely to be obtained, it is preferable to employ a method of producing a first cellulose porous body or a method of producing a second cellulose porous body described below. In addition, a cellulose porous body having a large area can be obtained and a transparent heat insulating member having a maximum length of 1000 mm or greater can be obtained, by employing the method of producing a first cellulose porous body or the method of producing a second cellulose porous body described below.

### (Method of Producing First Cellulose Porous Body)

The method of producing the first cellulose porous body includes, in the following order, a step of preparing a CNF dispersion liquid in which CNF is dispersed, a step of gelling the CNF dispersion liquid to obtain a CNF wet gel, a step of replacing a solvent component in the CNF wet gel, a step of freeze-drying the CNF wet gel to obtain a CNF aerogel, and a step of performing a water-repellent treatment on the CNF aerogel.

Hereinafter, each step will be described.

First, the CNF dispersion liquid in which CNF is dispersed is prepared.

The CNF dispersion liquid in which the CNF is dispersed can be obtained by, for example, the method described in the section of the method of preparing CNF.

It is preferable that the dispersion medium in the CNF dispersion liquid contains water. The dispersion medium contains preferably 70% by mass or greater of water, more preferably 90% by mass or greater of water, and still more preferably 99% by mass or greater of water with respect to the total mass of the dispersion medium. Further, the dispersion medium in the CNF dispersion liquid may be water.

The content of CNF in the CNF dispersion liquid is preferably 0.001% to 5% by mass, more preferably 0.01% to 2% by mass, and still more preferably 0.1% to 1% by mass.

Further, the CNF dispersion liquid may contain the above-described additives.

Next, the CNF dispersion liquid is gelled to obtain a CNF wet gel.

The method of gelling the CNF dispersion liquid is not particularly limited, and examples thereof include a method of adding an acidic component or an alkaline component. Among the examples, a method of adding an acidic component is preferable. In a case where the electrostatic repulsive force that contributes to the dispersion of CNFs in the CNF dispersion liquid is weakened by the addition of the above-described component, a network of CNFs is formed, and thus a CNF wet gel is obtained.

The acidic component to be added is not particularly limited, and examples thereof include an inorganic acid (for example, hydrochloric acid, sulfuric acid, nitric acid, or phosphoric acid), an organic acid (for example, methanesulfonic acid or tosylic acid), and a metal halide (for example, aluminum chloride). In addition, it is preferable that the acidic component is added to the CNF dispersion liquid in a state of a solution.

The amount of the acidic component to be added can be appropriately adjusted, but is, for example, preferably 0.01 to 5 mol/L with respect to the total volume of the CNF dispersion liquid after the addition of the acidic component.

In a case of adding the acidic component, it is also preferable that the acidic component is added without performing forced stirring and the mixture is allowed to stand.

Next, the solvent component in the CNF wet gel is replaced.

It is preferable that the solvent component in the CNF wet gel is replaced with a solvent in which fine crystals are precipitated during the subsequent freezing. Examples of the solvent in which fine crystals are precipitated include a mixed solvent. Among these, a mixed solvent of water and alcohol is preferable. It is preferable that the mixed solvent has a mixing ratio at which the components contained in the mixed solvent are precipitated as a eutectic in a case where the temperature is decreased. Examples of the alcohol include an alcohol that is miscible with water at any ratio, and preferred examples thereof include t-butyl alcohol. As the mixed solvent of water and t-butyl alcohol, a mixed solvent in which the content of water is 3% to 20% by mass with respect to the total mass of the mixed solvent is preferable, and a mixed solvent in which the content of water is 5% to 15% by mass with respect to the total mass of the mixed solvent is more preferable. Further, in the mixed solvent, it is preferable that the component other than water is t-butyl alcohol.

The solvent component in the CNF wet gel can be replaced by a known method, and for example, the CNF wet gel may be immersed in the mixed solvent. In this case, in order to promote the replacement, a shaking treatment may be performed.

Next, the CNF wet gel in which the solvent component has been replaced is freeze-dried to obtain a CNF aerogel.

The freezing may be carried out by a known method, but it is preferable that the CNF wet gel is rapidly cooled to be frozen from the viewpoint of reducing the size of crystals precipitated from the solvent contained in the CNF wet gel and obtaining a transparent heat insulating member having a higher transmittance. Examples of a method of rapidly cooling the CNF wet gel include a method of bringing the CNF wet gel into contact with a member cooled with liquid nitrogen.

The CNF wet gel is frozen, and the solvent component in the frozen CNF wet gel is sublimated. The solvent component may be sublimated while the environment of the frozen CNF wet gel is replaced with an environment at a freezing point lower than or equal to the freezing point of the solvent component. Further, in a case of sublimation of the solvent component, the pressure may be reduced to improve the sublimation rate.

Next, the CNF aerogel obtained by freeze-drying is subjected to a water-repellent treatment.

Examples of the water-repellent treatment include a method of supplying the above-described water-repellent component to the CNF aerogel. In a case of supplying the water-repellent component to the CNF aerogel, it is preferable that the water-repellent component is supplied in a gas phase. Examples thereof include a method of storing the above-described water-repellent component and the CNF aerogel in a chamber and heating the water-repellent component. In addition, a gas containing the water-repellent component described above may be supplied to the chamber where the CNF aerogel is stored.

The transparent heat insulating member (cellulose porous body) according to the embodiment of the present invention is obtained by performing the above-described steps.

### (Method of Producing Second Cellulose Porous Body)

The method of producing the second cellulose porous body is a production method including, in the following order, a step of preparing a CNF dispersion liquid in which CNF is dispersed and a water-repellent component is contained, a step of gelling the CNF dispersion liquid to obtain a CNF wet gel, a step of replacing a solvent component in the CNF wet gel, and a step of freeze-drying the CNF wet gel to obtain a CNF aerogel.

Here, the method of producing the second cellulose porous body is different from the method of producing the first cellulose porous body in terms that a CNF dispersion liquid in which CNF is dispersed and a water-repellent component is contained is used. As the water-repellent component, the above-described surfactant is preferable. The content of the water-repellent component in the CNF dispersion liquid may be appropriately adjusted such that the content of the water-repellent component in the cellulose porous body is in the above-described preferable ranges.

The method of producing the second cellulose porous body can be performed in the same manner as the method of producing the first cellulose porous body except for the above-described point, and thus the description thereof will not be provided.

Further, in a case where the method of producing the second cellulose porous body is employed, since a cellulose porous body more uniformly containing the water-repellent component can be obtained, and thus the cellulose porous body to be obtained can further maintain the transparency in a high-humidity.

In addition, as another embodiment of the method of producing a cellulose porous body, the freeze-drying performed in the method of producing the first cellulose porous body and the method of producing the second cellulose porous body may be replaced with a treatment of replacing the solvent component in the CNF wet gel with a supercritical fluid and drying the CNF wet gel.

### <Applications>

The transparent heat insulating member according to the embodiment of the present invention has high transparency and can be used for various applications. For example, the transparent heat insulating member can be suitably used for applications in which the heat insulation effects are exhibited. Specifically, the transparent heat insulating member according to the embodiment of the present invention can be suitably applied to a window or a member thereof. Hereinafter, specific examples of the transparent heat insulating member according to the embodiment of the present invention in a case of being applied to a window will be described, but the transparent heat insulating member according to the embodiment of the present invention is not limited to the following specific examples.

### [Laminated Glass]

The transparent heat insulating member according to the embodiment of the present invention can be applied to an interlayer film of laminated glass.

The configuration of the laminated glass is not particularly limited, and a known configuration can be used. For example, the number of glass plates used in the laminated glass may be 2 or more, 3 or more, or 4 or more.

In a case where the transparent heat insulating member according to the embodiment of the present invention is used as an interlayer film of the laminated glass, the transparent heat insulating member is disposed between two or more glass plates used in the laminated glass. However, in a case where the number of glass plates is three or more, the transparent heat insulating member according to the embodiment of the present invention may be disposed between each of the glass plates, or the transparent heat insulating member according to the embodiment of the present invention may be disposed only between a set of glass plates.

In the case where the transparent heat insulating member according to the embodiment of the present invention is used as an interlayer film of the laminated glass, a configuration (another layer) other than the transparent heat insulating member according to the embodiment of the present invention may be provided between a set of glass plates. That is, the transparent heat insulating member according to the embodiment of the present invention which is provided between the glass plates may be in direct contact with the glass plates or may be in contact with the glass plates through another layer.

Preferred examples of the other layers include one or more resin layers selected from the group consisting of polyvinyl butyral, polycarbonate, an ethylene-vinyl acetate copolymer, and polyethylene terephthalate.

As the other layers, an adhesive layer or a pressure-sensitive adhesive layer is also preferable.

In addition, other layers described in multi-layered glass below may be applied to the laminated glass.

As the glass plate used in the laminated glass, known glass can be used depending on the purpose thereof, and examples thereof include a transparent glass plate, a patterned glass plate, a wire glass plate, a wired glass plate, a reinforced glass plate, a heat ray reflecting glass plate, a heat ray absorbing glass plate, a Low-E glass plate, and various other glass plates. In addition, one or more of the glass plates used in the laminated glass may be formed of a glass substitute resin such as polycarbonate. The thickness of the glass plate can be appropriately selected depending on the purpose thereof.

The shape of the glass plate is not particularly limited and can be appropriately adjusted according to the applications. In addition, the glass plate may have a curved surface.

The laminated glass may have a known sealing structure. Examples of the sealing structure include a structure in which an outer edge portion of the laminated glass is sealed with a sealing material such as a resin.

### [Multi-Layered Glass]

The transparent heat insulating member according to the embodiment of the present invention can be applied to multi-layered glass.

The multi-layered glass denotes glass including a gas layer between two or more glass plates. The gas layer is a layer consisting of a gas, and the gas contained in the gas layer may be air or an inert gas such as nitrogen gas or argon gas. Further, the gas layer may be under reduced pressure lower than the atmospheric pressure.

The number of glass plates included in the multi-layered glass may be 2 or more, 3 or more, or 4 or more.

In a case where the transparent heat insulating member according to the embodiment of the present invention is applied to the multi-layered glass, the transparent heat insulating member according to the embodiment of the present invention is disposed between a set of glass plates. However, in a case where the number of glass plates is three or more, the transparent heat insulating member according to the embodiment of the present invention may be disposed between each of the glass plates or only between a set of glass plates.

In the case where the transparent heat insulating member according to the embodiment of the present invention is applied to the multi-layered glass, the multi-layered glass may have one or more configurations (other layers) in addition to the transparent heat insulating member according to the embodiment of the present invention.

Examples of the other layers include a light shielding layer and a heat insulating layer, in addition to the other layers described above.

The light shielding layer may be a layer having a low transmittance of at least a part of visible rays or a layer having a low transmittance of at least apart of ultraviolet rays. Examples of the light shielding layer include a metal vapor deposition film and a colored layer such as a coloring agent layer containing a coloring agent.

Examples of the heat insulating layer include a layer that reflects or absorbs infrared rays, and for example, a metal vapor deposition film, a polymer layer containing metal particles or metal oxide particles, and a dielectric multilayer film can be applied.

In addition, examples of the other layers also include a flame retardant layer. Examples of the flame retardant layer include a layer containing a flame retardant, and a known flame retardant can be applied as the flame retardant. Examples of the flame retardant include aromatic phosphoric acid ester, a phosphorus compound such as red phosphorus, a halogen-based compound such as chlorinated paraffin containing at least one of chlorine or bromine, an antimony compound such as antimony trioxide, a metal hydroxide such as aluminum hydroxide or magnesium hydroxide, and a nitrogen compound such as melamine cyanurate.

As the glass plate, a glass plate used in the above-described laminated glass can be applied.

In addition, the glass plate included in the multi-layered glass may be laminated glass. The laminated glass may be laminated glass including the transparent heat insulating member according to the embodiment of the present invention described above.

The multi-layered glass may have a known sealing structure. Examples of the sealing structure include a sealing structure formed of a spacer installed at an outer edge portion of a set of glass plates and a sealing structure formed of a sealing material disposed between a spacer and a glass plate facing the spacer. With the sealing structure, a space formed by a set of glass plates and a spacer is the above-described gas layer. The spacer may include a drying material for the purpose of absorbing moisture in the gas layer.

In addition, the outer edge portion side of the glass plate with respect to the spacer may be sealed with another sealing material. Examples of the other sealing materials include a cured resin such as a polysulfide-based resin and a silicone-based resin.

In addition, the sealing structure may be composed of a frame that holds the multi-layered glass.

In a case where the transparent heat insulating member according to the embodiment of the present invention is applied to the laminated glass and the multi-layered glass described above, the transparent heat insulating member that is integrally molded may be applied, or a plurality of transparent heat insulating members may be applied by being arranged in a plane direction of the glass plate. In addition, a plurality of transparent heat insulating members may be applied by being laminated in a lamination direction of the glass plate.

Further, in the case where the transparent heat insulating member according to the embodiment of the present invention is applied to the laminated glass and the multi-layered glass described above, the above-described flame retardant may be added to the transparent heat insulating member.

The laminated glass and the multi-layered glass described above can be suitably used, for example, as a window for a house or a window for a moving object such as a passenger car.

Further, the laminated glass and the multi-layered glass described above can transmit radio waves because the transparent heat insulating member according to the embodiment of the present invention does not have conductivity. In a case where radio waves are intended to be transmitted, it is preferable to select a layer having no conductivity as the above-described other layers.

### EXAMPLES

Hereinafter, the present invention will be described in more detail with reference to examples.

Materials, used amounts, ratios, treatment details, treatment procedures, and the like shown in the following examples can be appropriately changed within a range not departing from the scope of the present invention. Accordingly, the scope of the present invention will not be restrictively interpreted by the following examples.

### Example 1

### [Step of Preparing Cellulose Nanofiber Aqueous Dispersion Liquid]

2.00 g of NBKP (bleached kraft pulp of coniferous wood, mainly consisting of fibers having a fiber diameter of greater than 1000 nm) in terms of dry mass, 0.025 g of TEMPO (2,2,6,6-tetramethylpiperidin-1-oxy radical), and 0.25 g of sodium bromide were dispersed in 150 ml of water, and a 13% sodium hypochlorite aqueous solution was added thereto such that the amount of sodium hypochlorite reached 5.00 mmol with respect to 1.00 g of NBKP, to start the reaction. During the reaction, a 0.50 mol/L sodium hydroxide aqueous solution was added dropwise to maintain the pH at 10. After the reaction for 2 hours, the reactant was filtered and sufficiently washed with water, thereby obtaining an oxidized cellulose slurry. 0.15% by mass of the oxidized cellulose slurry was subjected to a defibration treatment at 15,000 rpm for 5 minutes using a biomixer (BM-2, manufactured by NISSEI Corporation) and further subjected to a defibration treatment for 20 minutes using an ultrasonic disperser (model US-300E, manufactured by NISSEI Corporation). Thereafter, the coarse fibers were removed by centrifugation to obtain a transparent cellulose nanofiber aqueous dispersion liquid. The obtained cellulose nanofiber aqueous dispersion liquid was concentrated with a rotary evaporator until the concentration of solid contents reached 0.40%, and used in the subsequent steps.

Hereinafter, the cellulose nanofiber aqueous dispersion liquid having a concentration of solid contents of 0.40% will also be referred to as “cellulose nanofiber aqueous dispersion liquid A”.

### [Gelling Step]

500 g of the cellulose nanofiber aqueous dispersion liquid A was poured into a petri dish having a size of 100 cm square, and 100 g of 1.0 M hydrochloric acid was gently allowed to flow down the wall surface and allowed to stand for 1 hour. The dispersion liquid was physically gelled, and the thickness thereof was 5 mm.

### [Solvent Replacement Step]

The solvent was replaced using a mixed solvent in which t-butyl alcohol and water were mixed at a mixing ratio of 90:10 in terms of mass ratio. The solvent was replaced by immersing the physical gel in a sufficient amount of a replacement solvent and slowly shaking the solution. Each replacement step was carried out for 4 hours, and replacement was performed 4 times or more.

### [Freeze-Drying Step]

The physical gel obtained in the solvent replacement step was sandwiched between upper and lower iron plates sufficiently cooled with liquid nitrogen (−196° C.) and was frozen. The solvent component of the frozen gel was sublimated using a vacuum dryer (manufactured by Tokyo Rikakikai Co., Ltd.) to obtain an aerogel.

### [Vapor Deposition Step]

The aerogel obtained in the freeze-drying step was placed in a sealed chamber, and 100 mg of trimethoxyheptadecafluorodecylsilane was put in the chamber as a water-repellent component. The chamber was kept at 60° C. for 1 hour, and triethoxyheptadecafluorodecylsilane was supplied to the aerogel, thereby obtaining a cellulose porous body.

### Example 2

A cellulose porous body was obtained in the same manner as in Example 1 except that trimethoxytrifluoropropylsilane was used as a water-repellent component in the vapor deposition step.

### Example 3

A cellulose porous body was obtained in the same manner as in Example 1 except that a 0.1 M aluminum chloride aqueous solution was used instead of hydrochloric acid in the gelling step.

### Example 4

A cellulose porous body was obtained in the same manner as in Example 1 except that trimethoxytrifluoropropylsilane was added as a water-repellent component.

### Example 5

A cellulose porous body was obtained in the same manner as in Example 1 except that potassium nonafluorobutanesulfonate was added to the cellulose nanofiber dispersion liquid A and the vapor deposition step was not performed. Further, the potassium nonafluorobutanesulfonate was added such that the content thereof reached 0.08% by mass with respect to the total mass of the potassium nonafluorobutanesulfonate and the cellulose nanofiber aqueous dispersion liquid A.

### Example 6

A cellulose porous body was obtained in the same manner as in Example 1 except that potassium bis(nonafluorobutanesulfonyl)imide was added to the cellulose nanofiber dispersion liquid A and the vapor deposition step was not performed. Further, the potassium bis(nonafluorobutanesulfonyl)imide was added such that the content thereof reached 0.08% by mass with respect to the total mass of the potassium bis(nonafluorobutanesulfonyl)imide and the cellulose nanofiber aqueous dispersion liquid A.

### Example 7

A cellulose porous body was obtained in the same manner as in Example 1 except that ethanol was used instead of the mixed solvent in the solvent replacement step and an aerogel was obtained by drying the ethanol in the following supercritical drying step.

### [Supercritical Drying Step]

The physical gel obtained by replacing the solvent was put into a sealed reactor, liquefied carbon dioxide was introduced into the sealed reactor, and the sealed reactor was heated and the pressure inside the sealed reactor was increased by a high-pressure pump so that carbon dioxide in the sealed reactor was in a supercritical state. Further, liquefied carbon dioxide was allowed to flow into the sealed reactor, and supercritical carbon dioxide was allowed to flow out of the sealed reactor so that the supercritical carbon dioxide was circulated in the physical gel in the sealed reactor. In a case where supercritical carbon dioxide was circulated in the physical gel from which the solvent had been replaced, the solvent was dissolved in the supercritical carbon dioxide, and the solvent was removed with the supercritical carbon dioxide flowing out of the sealed reactor.

The temperature and the pressure in the above-described sealed reactor were set to the temperature and the pressure at which carbon dioxide was in a supercritical state. In a case where the critical point of carbon dioxide was 31.1° C./7.38 MPa, the temperature and the pressure were set to, for example, 50° C. to 200° C. and 10 to 30 MPa.

### Comparative Example 1

A cellulose porous body was obtained in the same manner as in Example 1 except that the vapor deposition step was not performed.

### Comparative Example 2

t-Butyl alcohol was added to the cellulose nanofiber aqueous dispersion liquid A such that the t-butyl alcohol and water were mixed at a mixing ratio of 20:80 in terms of mass ratio, and a predetermined amount of potassium nonafluorobutanesulfonate was added thereto, thereby obtaining a cellulose nanofiber aqueous dispersion liquid B. Further, potassium nonafluorobutanesulfonate was added to the cellulose nanofiber aqueous dispersion liquid B such that the content thereof reached 0.08% by mass with respect to the total mass of the cellulose nanofiber aqueous dispersion liquid B. A cellulose porous body was obtained in the same manner as in Example 1 except that the cellulose nanofiber aqueous dispersion liquid B was used and the gelling step and the vapor deposition step were not performed.

### Comparative Example 3

A cellulose porous body was obtained in the same manner as in Example 7 except that the vapor deposition step was not performed.

### <Measurement and Evaluation>

### [Measurement of Fiber Diameter]

The fiber diameters of the cellulose porous bodies of the examples and the comparative examples were measured by the above-described method.

### [Evaluation of Transmittance]

The transmittances of the cellulose porous bodies of the examples and the comparative examples were measured using an ultraviolet-visible-near infrared spectrophotometer V-660 equipped with an automatic absolute reflectivity measuring unit ARMN-735 (manufactured by JASCO Corporation). Further, in the measurement, the sample was placed near an integrating sphere to measure the total light transmittance, and the transmittance was evaluated by the transmittance at 550 nm.

Further, the thicknesses of all the cellulose porous bodies of the examples and the comparative examples were 5 mm.

### (Evaluation of Moisture Resistance)

The cellulose porous bodies of the examples and the comparative examples were allowed to stand in a constant-temperature tank at a temperature of 20° C. and a relative humidity of 50% for 14 days. After standing, the transmittance was evaluated in the same manner as described above. The values obtained by subtracting the transmittances before standing from the transmittances after standing are listed in the tables shown below. That is, in a case where the transmittance after standing is lower than the transmittance before standing, the value is negative, and this indicates that the transparency can be maintained in a high-humidity as the negative value decreases.

### [Evaluation of Contact Angle]

The contact angles of the cellulose porous bodies with respect to water in the examples and the comparative examples were measured. The contact angle of water was measured in a case where water was dropped by using a water contact angle meter FAMAS (manufactured by Kyowa Interface Science Co., Ltd.).

### <Results>

Table 1 lists the preparation procedures, the fiber diameters, the transmittances, and the evaluation of moisture resistance of the cellulose porous bodies (transparent heat insulating members) of the examples and the comparative examples.

Further, the size of the prepared cellulose porous body (transparent heat insulating member) is listed in the columns of the size in Table 1.

TABLE 1

| | | | | Method of | | | | | | |
|---|---|---|---|---|---|---|---|---|---|---|
| | | | | introducing | | | | | | |
| | | | | water- | | | Fiber | Trans- | | Contact |
| | | Gelling | Replaced | repellent | Water-repellent | Drying | diameter | mittance | Moisture | angle |
| | Size | agent | solvent | component | component | method | (nm) | (%) | resistance | (deg) |
| Example 1 | 1 × | Hydrochloric | TBA:water = | Vapor | Trimethoxyheptadeca- | Freeze- | 35 nm | 70 | −3% | 110 |
| | 1 m | acid | 9:1 | deposition | fluorodecylsilane | drying | | | | |
| Example 2 | 1 × | Hydrochloric | TBA:water = | Vapor | Trimethoxyheptadeca- | Freeze- | 35 nm | 70 | −3% | 110 |
| | 1 m | acid | 9:1 | deposition | fluorodecylsilane | drying | | | | |
| Example 3 | 1 × | Aluminum | TBA:water = | Vapor | Trimethoxyheptadeca- | Freeze- | 35 nm | 70 | −3% | 110 |
| | 1 m | chloride | 9:1 | deposition | fluorodecylsilane | drying | | | | |
| Example 4 | 1 × | Hydrochloric | TBA:water = | Vapor | Trimethoxyheptadeca- | Freeze- | 35 nm | 70 | −5% | 95 |
| | 1 m | acid | 9:1 | deposition | fluoropropylsilane | drying | | | | |
| Example 5 | 1 × | Hydrochloric | TBA:water = | Mixing into | Potassium nonafluoro- | Freeze- | 35 nm | 70 | −1% | 120 |
| | 1 m | acid | 9:1 | dispersion | butanesulfonate | drying | | | | |
| | | | | liquid | | | | | | |
| Example 6 | 1 × | Hydrochloric | TBA:water = | Mixing into | Potassium | Freeze- | 35 nm | 70 | −1% | 120 |
| | 1 m | acid | 9:1 | dispersion | bis(nonafluoro- | drying | | | | |
| | | | | liquid | butanesulfonyl)imide | | | | | |
| Example 7 | 2 × | Hydrochloric | Ethanol | Vapor | Trimethoxyheptadeca- | Supercritical | 15 nm | 90 | −4% | 100 |
| | 2 cm | acid | | deposition | fluorodecylsilane | drying | | | | |
| Comparative | 1 × | Hydrochloric | TBA:water = | — | — | Freeze- | 35 nm | 70 | −21% | 0 |
| Example 1 | 1 m | acid | 9:1 | | | drying | | | | |
| Comparative | 1 × | — | TBA:water = | Mixing into | Potassium | Freeze- | 81 nm | 20 | −1% | 100 |
| Example 2 | 1 m | | 2:8 | dispersion | nonafluoro- | drying | | | | |
| | | | | liquid | butanesulfonate | | | | | |
| Comparative | 2 × | Hydrochloric | Ethanol | — | — | Supercritical | 15 nm | 90 | −32% | 0 |
| Example 3 | 2 cm | acid | | | | drying | | | | |

As shown in the results listed in Table 1, the cellulose porous bodies of Comparative Examples 1 and 3, which did not contain the water-repellent component, could not maintain the transparency in a high-humidity environment as compared with each example. In addition, as shown in the results of Comparative Example 2, in a case where the fiber diameter was 40 nm or greater, the transmittance was low, and the cellulose porous body could not be used as a transparent heat insulating member.

Based on the comparison between Example 4 and Examples 1 to 3, 5, and 6, it was confirmed that in a case where the cellulose porous body contained a compound containing a fluorinated alkyl group as the water-repellent component and the fluorinated alkyl group had 4 to 12 carbon atoms, the transparency could be further maintained in a high-humidity.

Based on the comparison between Examples 5 and 6 and other examples, it was confirmed that in a case where the cellulose porous body contained a surfactant containing a fluorinated alkyl group as the water-repellent component, the transparency could be further maintained in a high-humidity.

Based on the comparison between Example 7 and other examples, it was confirmed that in a case where the fiber diameter was 20 to 40 nm, the transparency could be further maintained in a high-humidity.

Based on the comparison between Example 7 and other examples, it was confirmed that in a case where the method of producing the first cellulose porous body or the method of producing the second cellulose porous body described above was employed, a cellulose porous body having a large area could be obtained and a transparent heat insulating member having a maximum length of 1000 mm or greater could be obtained.

Based on the comparison between Example 4 and Examples 1 to 3, it was confirmed that in a case where the water-repellent component was a compound containing a fluorinated alkyl group and the fluorinated alkyl group in the compound containing a fluorinated alkyl group had 4 to 12 carbon atoms, the contact angle was further increased.

What is claimed is:

1. A transparent heat insulating member comprising:
a cellulose porous body,
wherein the cellulose porous body contains a cellulose nanofiber and a water-repellent component, and
the cellulose porous body has a fiber diameter of 3 to 40 nm.

2. The transparent heat insulating member according to claim 1,
wherein the transparent heat insulating member has a maximum length of 1000 mm or greater.

3. The transparent heat insulating member according to claim 1,
wherein the transparent heat insulating member has a contact angle of 90 degrees or greater with respect to water.

4. The transparent heat insulating member according to claim 1,
wherein the water-repellent component is a compound containing a fluorinated alkyl group.

5. The transparent heat insulating member according to claim 4,
wherein in the compound containing a fluorinated alkyl group, the fluorinated alkyl group has 4 to 12 carbon atoms.

6. The transparent heat insulating member according to claim 4,
wherein the compound containing a fluorinated alkyl group is an alkoxysilane containing a fluorinated alkyl group or a condensate of the alkoxysilane.

7. The transparent heat insulating member according to claim 6,
wherein the alkoxysilane is a compound represented by Formula (I), 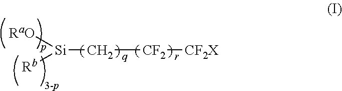
in Formula (I), R^{a} represents an alkyl group having 1 to 4 carbon atoms, in a case where a plurality of R^{a}'s are present, R^{a}'s may be the same as or different from each other,
R^{b} represents an alkyl group having 1 to 4 carbon atoms, in a case where a plurality of R^{b}'s are present, R^{b}'s may be the same as or different from each other,
p represents an integer of 1 to 3,
q represents an integer of 0 to 10,
r represents an integer of 0 to 19, and
X represents a hydrogen atom or a fluorine atom.

8. The transparent heat insulating member according to claim 2,
wherein the transparent heat insulating member has a contact angle of 90 degrees or greater with respect to water.

9. The transparent heat insulating member according to claim 2,
wherein the water-repellent component is a compound containing a fluorinated alkyl group.

10. The transparent heat insulating member according to claim 9,
wherein in the compound containing a fluorinated alkyl group, the fluorinated alkyl group has 4 to 12 carbon atoms.

11. The transparent heat insulating member according to claim 9,
wherein the compound containing a fluorinated alkyl group is an alkoxysilane containing a fluorinated alkyl group or a condensate of the alkoxysilane.

12. The transparent heat insulating member according to claim 11,
wherein the alkoxysilane is a compound represented by Formula (I), 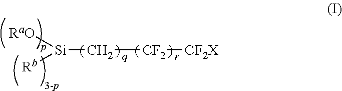
in Formula (I), R^{a} represents an alkyl group having 1 to 4 carbon atoms, in a case where a plurality of R^{a}'s are present, R^{a}'s may be the same as or different from each other,
R^{b} represents an alkyl group having 1 to 4 carbon atoms, in a case where a plurality of R^{b}'s are present, R^{b}'s may be the same as or different from each other,
p represents an integer of 1 to 3,
q represents an integer of 0 to 10,
r represents an integer of 0 to 19, and
X represents a hydrogen atom or a fluorine atom.

13. The transparent heat insulating member according to claim 3,
wherein the water-repellent component is a compound containing a fluorinated alkyl group.

14. The transparent heat insulating member according to claim 13,
wherein in the compound containing a fluorinated alkyl group, the fluorinated alkyl group has 4 to 12 carbon atoms.

15. The transparent heat insulating member according to claim 13,
wherein the compound containing a fluorinated alkyl group is an alkoxysilane containing a fluorinated alkyl group or a condensate of the alkoxysilane.

16. The transparent heat insulating member according to claim 13,
wherein the alkoxysilane is a compound represented by Formula (I), 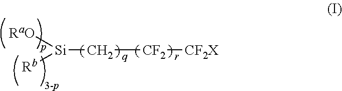
in Formula (I), R^{a} represents an alkyl group having 1 to 4 carbon atoms, in a case where a plurality of R^{a}'s are present, R^{a}'s may be the same as or different from each other,
R^{b} represents an alkyl group having 1 to 4 carbon atoms, in a case where a plurality of R^{b}'s are present, R^{b}'s may be the same as or different from each other,
p represents an integer of 1 to 3,
q represents an integer of 0 to 10,
r represents an integer of 0 to 19, and
X represents a hydrogen atom or a fluorine atom.

17. The transparent heat insulating member according to claim 8,
wherein the water-repellent component is a compound containing a fluorinated alkyl group.

18. The transparent heat insulating member according to claim 17,
wherein in the compound containing a fluorinated alkyl group, the fluorinated alkyl group has 4 to 12 carbon atoms.

19. The transparent heat insulating member according to claim 17,
wherein the compound containing a fluorinated alkyl group is an alkoxysilane containing a fluorinated alkyl group or a condensate of the alkoxysilane.

20. The transparent heat insulating member according to claim 17,
wherein the alkoxysilane is a compound represented by Formula (I), 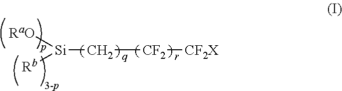
in Formula (I), R^{a} represents an alkyl group having 1 to 4 carbon atoms, in a case where a plurality of R^{a}'s are present, R^{a}'s may be the same as or different from each other,
R^{b} represents an alkyl group having 1 to 4 carbon atoms, in a case where a plurality of R^{b}'s are present, R^{b}'s may be the same as or different from each other,
p represents an integer of 1 to 3,
q represents an integer of 0 to 10,
r represents an integer of 0 to 19, and
X represents a hydrogen atom or a fluorine atom.
